(19) United States
(12) Patent Application Publication
(10) Pub. No.: US 2025/0095348 A1
(43) Pub. Date: Mar. 20, 2025

(54) COMMUNICATION-AWARE INFERENCE SERVING FOR PARTITIONED NEURAL NETWORKS

(71) Applicant: Cisco Technology, Inc., San Jose, CA (US)

(72) Inventors: Myungjin Lee, Bellevue, WA (US); Gustav Adrian Baumgart, Seattle, WA (US); Jaemin Shin, Seattle, WA (US); Ramana Rao V.R. Kompella, Foster City, CA (US)

(21) Appl. No.: 18/368,790

(22) Filed: Sep. 15, 2023

(51) Int. Cl. G06V 10/82; G06V 10/771

(52) U.S. Cl. CPC G06V 10/82; G06V 10/771

(57) ABSTRACT

In one implementation, a device generates outputs of nodes in a upstream layer of a partitioned neural network. The device assigns priorities to each of the outputs of the nodes. The device selects, based on the priorities, a subset of the outputs to send to a remote device. The device sends, via a computer network, the subset of the outputs to the remote device for input to a downstream layer of the partitioned neural network.

### TECHNICAL FIELD

The present disclosure relates generally to computer networks, and, more particularly, to communication-aware inference serving for partitioned neural networks.

### BACKGROUND

As machine learning/artificial intelligence techniques continue to evolve and mature, the number of use cases for these techniques also continue to increase. For instance, video analytics techniques are becoming increasingly ubiquitous as a complement to new and existing surveillance systems. In such deployments, a neural network-based person detection and reidentification now allows for a specific person to be tracked across different video feeds throughout a location. More advanced video analytics techniques also attempt to detect certain types. Other use cases also range from sensor analytics, to (semi-)autonomous vehicles, to network security, to name a few

While machine learning/artificial intelligence techniques such as neural networks are quite promising, the more capable the neural network model, the more resource intensive the model is to execute. In cases in which the model is too large to execute on a singular device, the model could be partitioned into smaller pieces (e.g., by dividing its layers) for execution in a distributed manner. Then, each device may perform its inference using its own portion of the model before sending the results on to the next device in the chain, sequentially. However, when the network connectivity between the devices is bandwidth limited or exhibits high latency, the communication bottleneck could increase the inference latency of the partitioned model.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example system for performing video analytics;

FIG. 4 illustrates an example of sending only a subset of outputs across a partitioned neural network executed by multiple devices;

FIGS. 5A-5D illustrate examples of performing knockout on a partitioned neural network;

FIG. 6 illustrates an example of communication-aware inference serving for a partitioned neural network; and

FIG. 7 illustrates an example simplified procedure for communication-aware inference serving for partitioned neural networks.

### DESCRIPTION OF EXAMPLE IMPLEMENTATIONS

### Overview

According to one or more implementations, a device generates outputs of nodes in a upstream layer of a partitioned neural network. The device assigns priorities to each of the outputs of the nodes. The device selects, based on the priorities, a subset of the outputs to send to a remote device. The device sends, via a computer network, the subset of the outputs to the remote device for input to a downstream layer of the partitioned neural network.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or wired networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

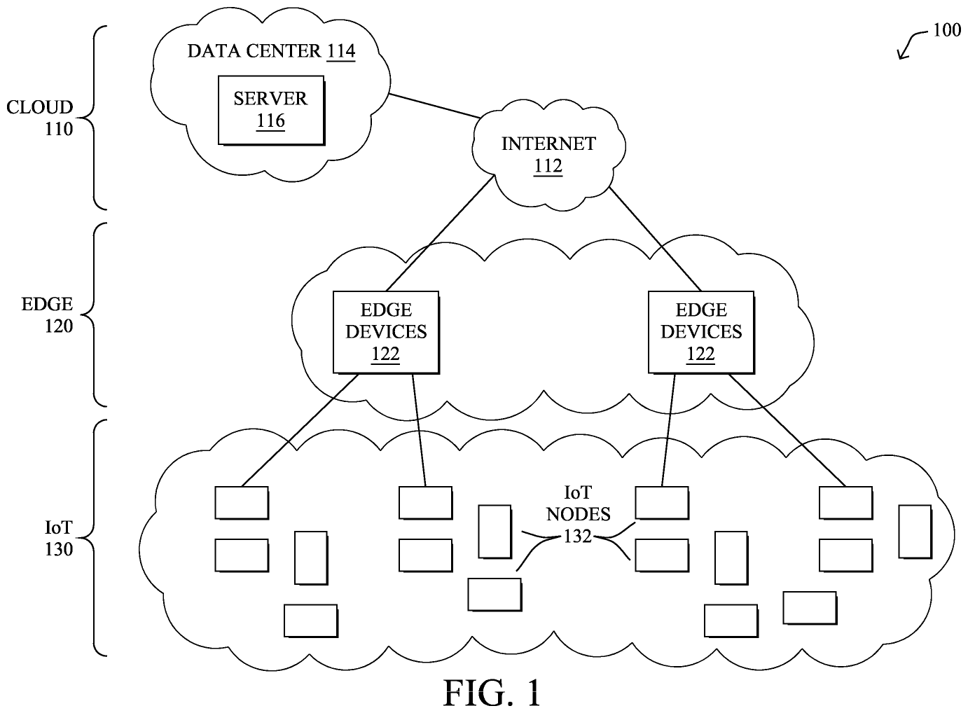

FIG. 1 is a schematic block diagram of an example simplified computer network 100 illustratively comprising nodes/devices at various levels of the network, interconnected by various methods of communication. For instance, the links may be wired links or shared media (e.g., wireless links, wired links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), or other shared-media protocols where appropriate. In this context, a protocol consists of a set of rules defining how the nodes interact with each other.

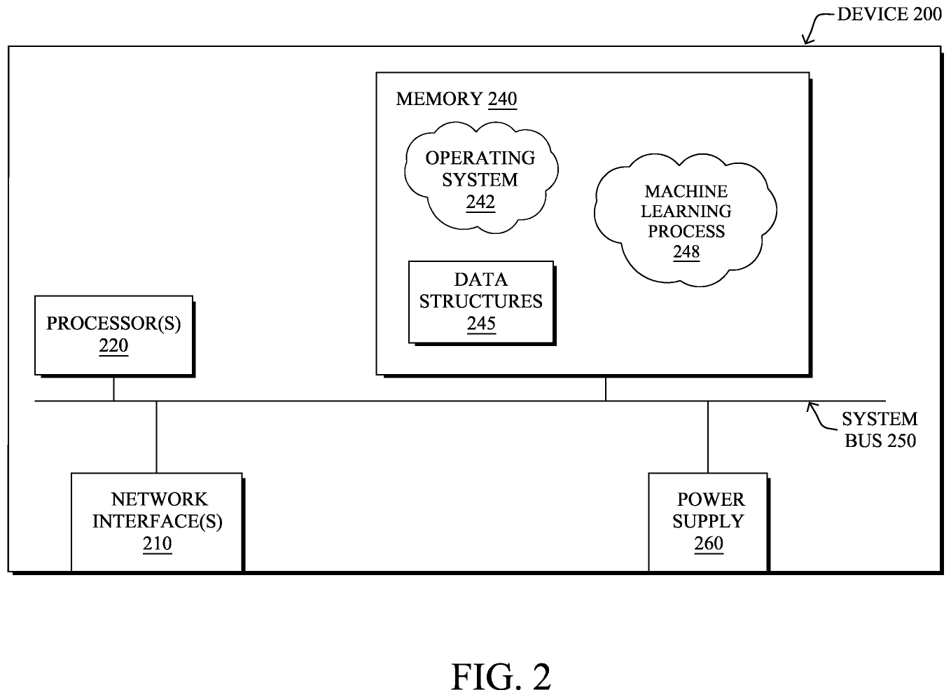

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative machine learning process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various implementations, machine learning process 248 may employ one or more supervised, unsupervised, or self-supervised machine learning models. Generally, supervised learning entails the use of a training set of data that is used to train the model to apply labels to the input data. For example, the training data may include sample video data depicting a particular event that has been labeled as such. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Self-supervised learning models take a middle ground approach that uses a greatly reduced set of labeled training data.

Example machine learning techniques that machine learning process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further implementations, machine learning process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that assesses video data to identify a certain type of object or event. In such a case, the false positives of the model may refer to the number of times the model incorrectly flagged the video data as depicting the type of object or event. Conversely, the false negatives of the model may refer to the number of times the model incorrectly determined that the video data does not depict the type of object or event. True negatives and positives may refer to the number of times the model correctly identified the video as not depicting the object/event or depicting it, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

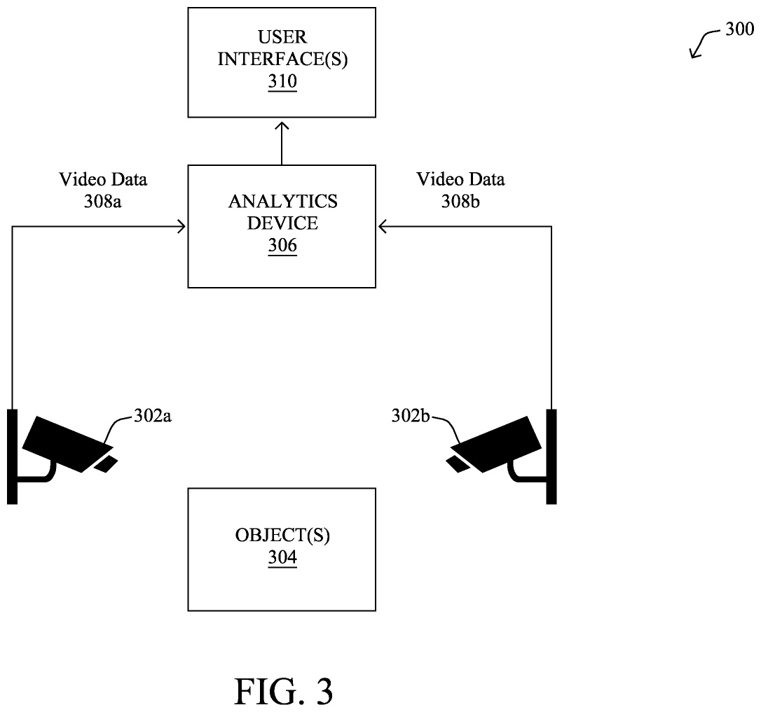

FIG. 3 illustrates an example system 300 for performing video analytics, as described in greater detail above. As shown, there may be any number of cameras 302 deployed to a physical area, such as cameras 302a-302b. Such surveillance is now fairly ubiquitous across various locations including, but not limited to, public transportation facilities (e.g., train stations, bus stations, airports, etc.), entertainment facilities (e.g., sports arenas, casinos, theaters, etc.), schools, office buildings, and the like. In addition, so-called “smart” cities are also now deploying surveillance systems for purposes of monitoring vehicular traffic, crime, and other public safety events.

Regardless of the deployment location, cameras 302a-302b may generate and send video data 308a-308b, respectively, to an analytics device 306 (e.g., a device 200 executing machine learning process 248 in FIG. 2). For instance, analytics device 306 may be an edge device (e.g., an edge device 122 in FIG. 1), a remote server (e.g., a server 116 in FIG. 1), or may even take the form of a particular endpoint in the network, such as a dedicated analytics device, a particular camera 302, or the lie.

In general, analytics device 306 may be configured to provide video data 308a-308b for display to one or more user interfaces 310, as well as to analyze the video data for events that may be of interest to a potential user. To this end, analytics device 306 may perform object detection on video data 308a-308b, to detect and track any number of objects 304 present in the physical area and depicted in the video data 308a-308b. In some implementations, analytics device 306 may also perform object re-identification on video data 308a-308b, allowing it to recognize an object 304 in video data 308a as being the same object in video data 308b or vice-versa.

As noted above, as machine learning/artificial intelligence techniques continue to evolve and mature, the number of use cases for these techniques also continue to increase. For instance, video analytics techniques are becoming increasingly ubiquitous as a complement to new and existing surveillance systems. In such deployments, a neural network-based person detection and reidentification now allows for a specific person to be tracked across different video feeds throughout a location. More advanced video analytics techniques also attempt to detect certain types. Other use cases also range from sensor analytics, to (semi-)autonomous vehicles, to network security, to name a few

While machine learning/artificial intelligence techniques such as neural networks are quite promising, the more capable the neural network model, the more resource intensive the model is to execute. In cases in which the model is too large to execute on a singular device, the model could be partitioned into smaller pieces (e.g., by dividing its layers) for execution in a distributed manner. Then, each device may perform its inference using its own portion of the model before sending the results on to the next device in the chain, sequentially. However, when the network connectivity between the devices is bandwidth limited or exhibits high latency, the communication bottleneck could increase the inference latency of the partitioned model.

### —Communication-Aware Inference Serving for Partitioned Neural Networks—

The techniques herein provide for the partitioning of a neural network for distributed processing in a manner that is optimized in view of the available network connectivity. In some aspects, a first device executing a portion of the neural network may send only a subset of the outputs of one of the layers of the neural network to another device for input to another layer of the neural network.

Illustratively, the techniques described herein may be performed by hardware, software, and/or firmware, such as in accordance with the machine learning process 248, which may include computer executable instructions executed by the processor 220 (or independent processor of interfaces 210), to perform functions relating to the techniques described herein.

Specifically, according to various implementations, a device generates outputs of nodes in an upstream layer of a partitioned neural network. The device assigns priorities to each of the outputs of the nodes. The device selects, based on the priorities, a subset of the outputs to send to a remote device. The device sends, via a computer network, the subset of the outputs to the remote device for input to a downstream layer of the partitioned neural network.

Operationally, in order to decrease communication costs between the devices executing the partitioned neural network, the techniques herein propose communicating fewer outputs from a previous layer to the next layer on another device. Indeed, one observation herein is that it is possible that not all weights contribute significantly to the classification/inference of the partitioned neural network.

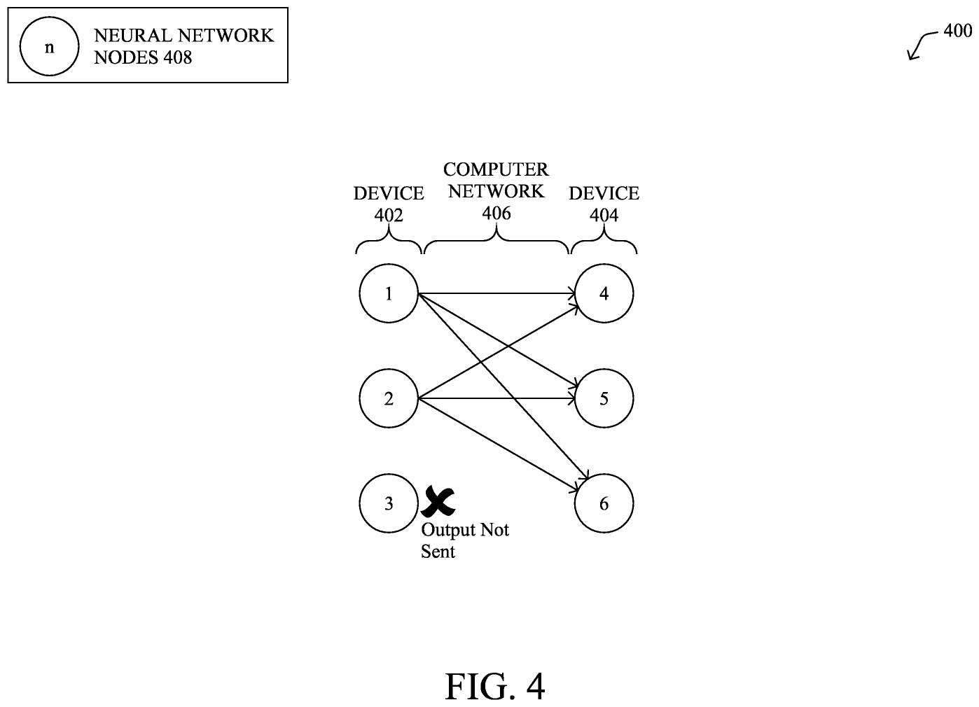

According to various implementations, FIG. 4 illustrates an example 400 of sending only a subset of outputs across a partitioned neural network executed by multiple devices. As shown, assume that there is a neural network having n-number of nodes 408 that has been partitioned for execution across any number of different devices (e.g., edge devices 122 in FIG. 1, etc.). Consequently, any given device executing a portion of the neural network may select only a portion of the outputs of any given layer of the neural network to be sent onward to the next device in the chain for input to the next layer of the neural network.

For instance, the neural network may be trained to perform sensor analytics on sensor data collected by any number of sensors in computer network 406, network monitoring or control functions based on telemetry from any number of networking devices in computer network 406, video analytics tasks based on video data from one or more cameras in computer network 406, to name a few.

More specifically, assume that a first device 402 executes a layer of the neural network that includes nodes 1-3 from nodes 408 and a second device 404 executes the next layer of the neural network that includes nodes 4-6 from nodes 408. As would be appreciated, the partitioned neural network may include any number of layers and that only two layers are shown for purposes of simplicity. For instance, the layer comprising nodes 1-3 may take as input the outputs of the nodes 408 in a preceding layer, which may also be executed by device 402 or another device. Similarly, device 404 may provide the outputs of the layer comprising nodes 4-6 for input to the nodes 408 in a further layer that is executed either by device 404 or another device.

While partitioning the neural network allows for its resource consumption to be spread across any number of devices, such as device 402 and device 404, doing so also makes the performance of the full neural network a function of the performance of the computer network 406 that connects device 402 to device 404. For instance, any latency in computer network 406 can result in a computational bottleneck for the overall neural network.

To help reduce the bandwidth consumed in sending the layer output from device 402 to device 404, the techniques herein propose device 402 blocking the outputs of one or more of the nodes (e.g., nodes 1-3) in the current layer from being sent to device 404 for input to its own layer. For instance, device 402 may block the output of node 3 from being sent to device 404 via computer network 406, while still sending the subset of outputs from nodes 1-2 to device 404.

Naturally, less information conveyed from one layer to another in the neural network is likely to negatively impact the accuracy of the neural network. To address this, the techniques herein propose device 402 prioritizing the outputs of nodes 1-3 in the current layer, to dynamically block one or more of those nodes from reporting its output to device 404 for input to the next layer. In some instances, this prioritization could be based on an offline computation of the neural network, before the partitioned inference takes place between devices.

In some implementations, the reporting device may assign priorities to the outputs of the different nodes in the current layer based on their mutual information, which could be gathered after the training process of the neural network is complete. To do so, the system may sue a knockout technique to calculate the impact of eliminating information from the previous layer, thereby allowing the reporting device to understand the impact of blocking the outputs from any given node on the performance of the neural network.

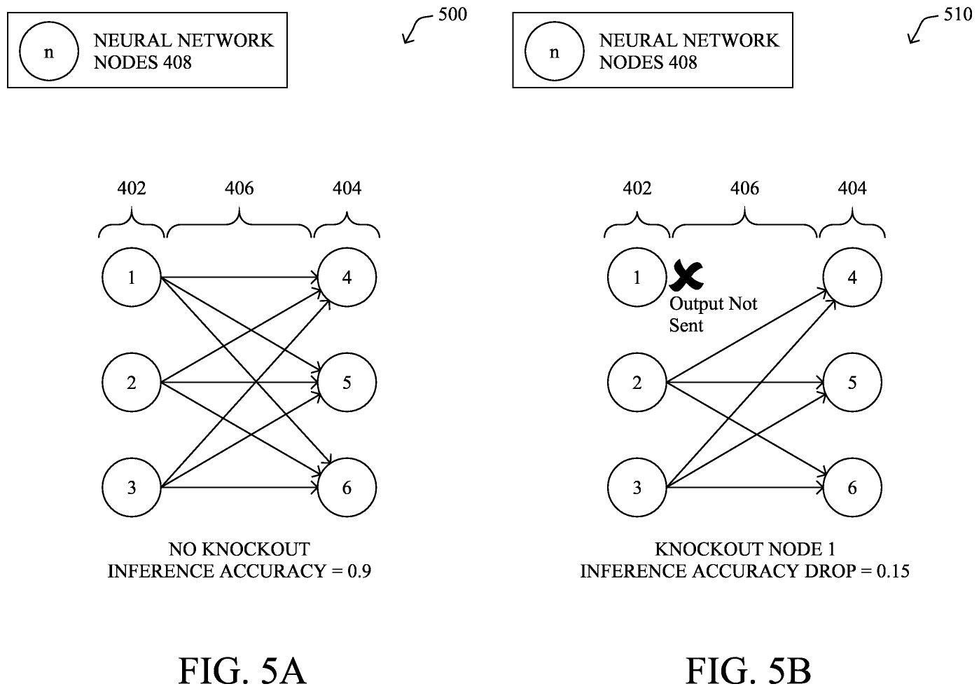

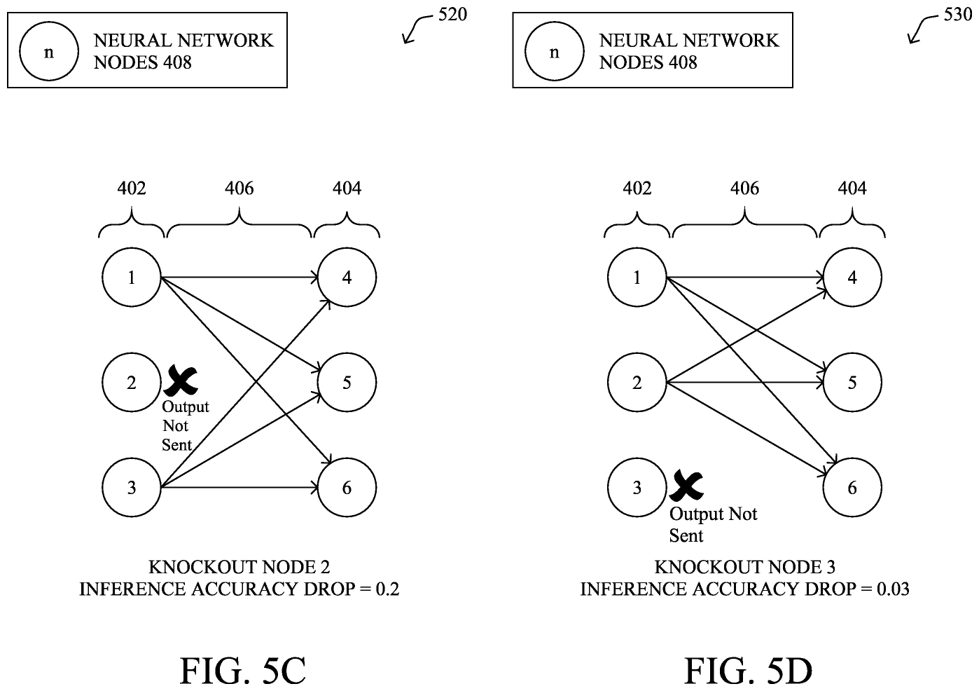

FIGS. 5A-5D illustrate examples of performing knockout on a partitioned neural network, in various implementations. As shown, again consider the partitioned neural network of FIG. 4 comprising nodes 408 that are executed in a distributed manner across device 402 and device 404 via computer network 406. In order to determine the effects of blocking the outputs of different nodes 408 on the performance of the neural network, the knockout procedure may execute the full neural network by not blocking any of the outputs of the nodes 408, as shown in example 500 in FIG. 5A. When fully executed, the performance of the neural network may be an inference accuracy of 0.9.

As shown in example 510 in FIG. 5B, device 402 blocking the output of node 1 from being sent to device 404 for input to the next layer of the partitioned neural network. Doing so results in a drop in the inference accuracy of the neural network by 0.15.

In example 520 in FIG. 5C, device 402 blocking the output of node 2 from being sent to device 404 for input to the next layer of the partitioned neural network. Doing so results in a drop in the inference accuracy of the neural network by 0.2.

In example 530 in FIG. 5D, device 402 blocking the output of node 3 from being sent to device 404 for input to the next layer of the partitioned neural network. Doing so results in a drop in the inference accuracy of the neural network by 0.03.

As a result of the knockout testing, the system may rank the nodes of the partitioned neural network nodes 408 as follows:

TABLE 1

| Node | Rank | Importance |
|---|---|---|
| 1 | 2 | 0.15 |
| 2 | 1 | 0.2 |
| 3 | 3 | 0.03 |

Thus, blocking the output of node 3 will have significantly less of an impact on the overall performance of the partitioned neural network than that of node 2, for instance.

Note that mutual information via knockout testing is one potential way for the system to rank the priorities of the node outputs from the previous layer. However, in further implementations, other ranking approaches are also possible. For instance, in an alternate implementation, the system could instead use the mean and standard deviation of the output values on device 402 to calculate the importance of the input to device 402. Unlike mutual information, however, this approach's ranking will depend on the output of device 402. Furthermore, the system may also estimate the effect of reduced communication by using mutual information.

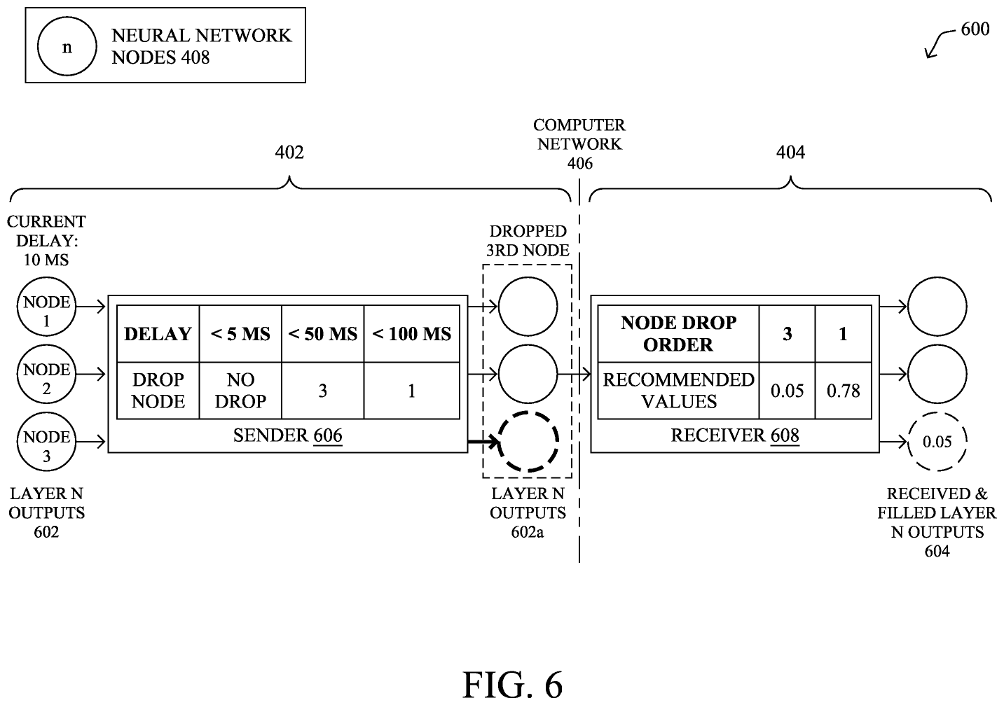

FIG. 6 illustrates an example 600 of communication-aware inference serving for a partitioned neural network, in various implementations. Continuing the example of FIG. 4, consider the case in which device 402 executes a layer of the partitioned neural network and device 404 executes a subsequent layer of that neural network. Thus, during execution, device 402 may generate a set 602 of node outputs from nodes 1-3.

In various implementations, device 402 may include a sender module 606 that sends node outputs to a receiver module 608 of device 404 via computer network 406 (e.g., components of machine learning process 248). Depending on one or more defined policies, sender module 606 may selectively block the output of one or more of the nodes 408 of device 402 from being sent via computer network 406 to device 404, based on the priorities assigned to those nodes.

For example, as shown, assume that the current delay/latency of the network path in computer network 406 between device 402 and device 404 is 10 ms. One potential policy may specify that if the path delay/latency is below a threshold of 5 ms, sender module 606 should opt to send all of set 602 to device 404, as computer network 406 introduces only minimal latency to the processing of the partitioned neural network.

Another policy, though, may specify that if the delay/latency is outside of this range, but is still below a threshold of 50 ms, sender module 606 should block the output of node 3 from being sent, instead sending only a subset 602a of the node outputs via computer network 406 to device 404 for input to the next layer of the partitioned neural network.

A further policy may specify that if the delay/latency is outside of the two ranges above, but below 100 ms, sender module 606 should drop not only the output of node 3, per the policy above, but also the output of node 1, as well. In such a case, the sent subset to device 404 would only include the output of node 2.

As shown, another function of receiver module 608 may also be to fill in any missing values from the previous layer, in various implementations. In other words, based on subset 602a, receiver module 608 may generate a set 604 of weights for input to the next layer of device 404 by filling in any of the missing values from subset 602a. For instance, in the case shown, receiver module 608 may assign a weight/value of 0.05 to the missing output from node 1 for further processing by the next layer of the partitioned neural network. Similarly, if sender module 606 also blocks the output of node 3 from being sent, receiver module 608 may assign a value/weight of 0.78 to it, as well. These substitute values of receiver module 608 may be precomputed and prestored by receiver module 608, thus requiring no additional communication via computer network 406.

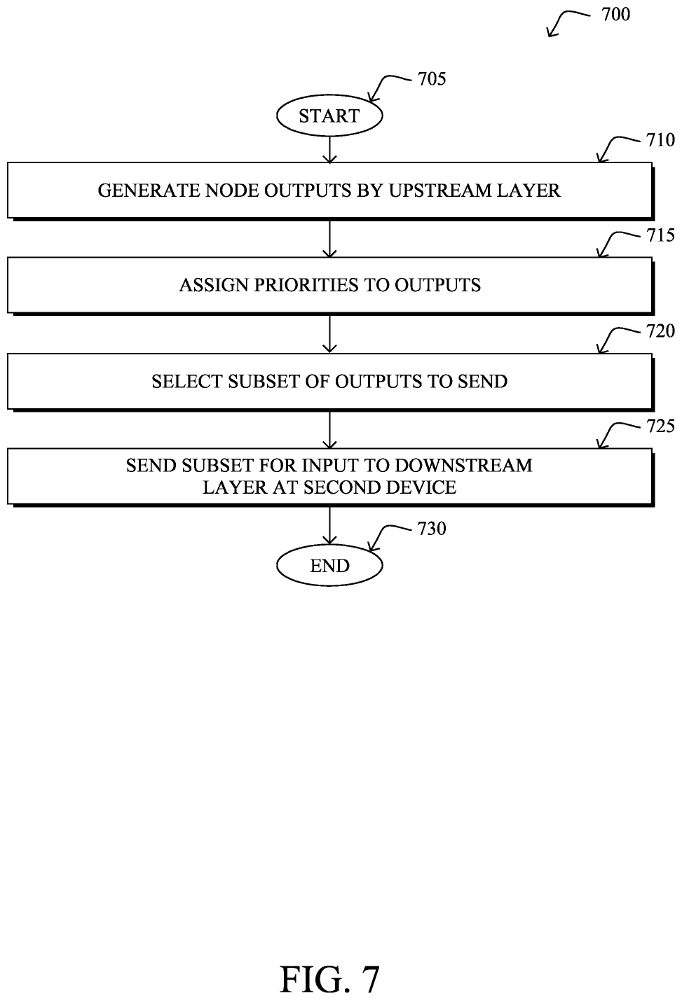

FIG. 7 illustrates an example simplified procedure 700 (e.g., a method) for communication-aware inference serving for partitioned neural networks, in accordance with one or more implementations described herein. For example, a non-generic, specifically configured device (e.g., device 200) may perform procedure 700 by executing stored instructions (e.g., machine learning process 248). The procedure 700 may start at step 705, and continues to step 710, where, as described in greater detail above, the device may generate outputs of nodes in an upstream layer of a partitioned neural network. In some implementations, the partitioned neural network is configured to analyze sensor data captured by one or more sensors in the computer network. For instance, the sensor data may comprise video data captured by one or more cameras in the computer network. In some implementations, the device may input outputs of a prior layer of the partitioned neural network to the upstream layer of the partitioned neural network.

At step 715, as detailed above, the device may assign priorities to each of the outputs of the nodes. In some implementations, the device may also perform knockout to determine accuracy losses associated with blocking outputs of each of the nodes in the upstream layer of the partitioned neural network. In such cases, the priorities may also be based on the accuracy losses. In further implementations, the priorities may be based on a mean and standard deviation of the outputs of the nodes in the upstream layer.

At step 720, the device may select, based on the priorities, a subset of the outputs to send to a remote device, as described in greater detail above. In some implementations, the device selects the subset of the outputs to send to the remote device based further on a latency associated with a path between the device and the remote device in the computer network. In some cases, the device may also opt to send all outputs of the nodes in the upstream layer to the remote device when the latency is below a threshold.

At step 725, as detailed above, the device may send, via a computer network, the subset of the outputs to the remote device for input to a downstream layer of the partitioned neural network. In some implementations, the device and the remote device are edge devices in the computer network.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for communication-aware inference serving for partitioned neural networks, it is to be understood that various other adaptations and modifications may be made within the spirit and scope of the implementations herein. For example, while certain implementations are described herein with respect to specific use cases for the techniques herein, the techniques can be extended without undue experimentation to other use cases, as well.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof, that cause a device to perform the techniques herein. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
generating, by a device, outputs of nodes in an upstream layer of a partitioned neural network;
assigning, by device, priorities to each of the outputs of the nodes;
selecting, by the device and based on the priorities, a subset of the outputs to send to a remote device; and
sending, by the device and via a computer network, the subset of the outputs to the remote device for input to a downstream layer of the partitioned neural network.

2. The method as in claim 1, wherein the device selects the subset of the outputs to send to the remote device based further on a latency associated with a path between the device and the remote device in the computer network.

3. The method as in claim 2, further comprising:
opting, by the device, to send all outputs of the nodes in the upstream layer to the remote device when the latency is below a threshold.

4. The method as in claim 1, further comprising:
performing knockout to determine accuracy losses associated with blocking outputs of each of the nodes in the upstream layer of the partitioned neural network.

5. The method as in claim 4, wherein the priorities are based on the accuracy losses.

6. The method as in claim 1, wherein the partitioned neural network is configured to analyze sensor data captured by one or more sensors in the computer network.

7. The method as in claim 6, wherein the sensor data comprises video data captured by one or more cameras in the computer network.

8. The method as in claim 1, wherein the priorities are based on a mean and standard deviation of the outputs of the nodes in the upstream layer.

9. The method as in claim 1, wherein the device selects the subset of the outputs to send to the remote device based on one or more policies.

10. The method as in claim 1, further comprising:
inputting, by the device, outputs of a prior layer of the partitioned neural network to the upstream layer of the partitioned neural network.

11. An apparatus, comprising:
a network interface to communicate with a computer network;
a processor coupled to the network interface and configured to execute one or more processes; and
a memory configured to store a process that is executed by the processor, the process when executed configured to:
generate outputs of nodes in an upstream layer of a partitioned neural network;
assign priorities to each of the outputs of the nodes;
select, based on the priorities, a subset of the outputs to send to a remote device; and
send, via a computer network, the subset of the outputs to the remote device for input to a downstream layer of the partitioned neural network.

12. The apparatus as in claim 11, wherein the apparatus selects the subset of the outputs to send to the remote device based further on a latency associated with a path between the apparatus and the remote device in the computer network.

13. The apparatus as in claim 12, wherein the process when executed is further configured to:
opt to send all outputs of the nodes in the upstream layer to the remote device when the latency is below a threshold.

14. The apparatus as in claim 11, wherein the process when executed is further configured to:
perform knockout to determine accuracy losses associated with blocking outputs of each of the nodes in the upstream layer of the partitioned neural network.

15. The apparatus as in claim 14, wherein the priorities are based on the accuracy losses.

16. The apparatus as in claim 11, wherein the partitioned neural network is configured to analyze sensor data captured by one or more sensors in the computer network.

17. The apparatus as in claim 16, wherein the sensor data comprises video data captured by one or more cameras in the computer network.

18. The apparatus as in claim 11, wherein the priorities are based on a mean and standard deviation of the outputs of the nodes in the upstream layer.

19. The apparatus as in claim 11, wherein the apparatus and the remote device are edge devices in the computer network.

20. A tangible, non-transitory, computer-readable medium storing program instructions that cause a device in a computer network to execute a process comprising:
generating, by the device, outputs of nodes in an upstream layer of a partitioned neural network;
assigning, by device, priorities to each of the outputs of the nodes;
selecting, by the device and based on the priorities, a subset of the outputs to send to a remote device; and
sending, by the device and via the computer network, the subset of the outputs to the remote device for input to a downstream layer of the partitioned neural network.
